(19) United States
(12) Patent Application Publication
(10) Pub. No.: US 2005/0285719 A1
(43) Pub. Date: Dec. 29, 2005

(54) Method and apparatus to manage reverse data flow in a high throughput wireless network

(75) Inventor: Adrian P. Stephens, Cambridge (GB)

Correspondence Address: The Law offices of John C. Scott, LLC;c/o PortfolioIP, P.O. Box 52050, Minneapolis, MN, 55402, US

(73) Assignee: Intel Corporation

(21) Appl. No.: 10/875,753

(22) Filed: Jun. 24, 2004

(51) Int. Cl. H04Q 5/22

(52) U.S. Cl. 340/10.2; 370/345

(57) ABSTRACT

An initiator device in a high throughput wireless network is able to communicate with multiple responder devices during a wireless frame exchange. In at least one embodiment of the invention, the initiator may transmit a frame that includes offset and duration related information for each of multiple responders. The offset and duration related information for each responder identifies a transmit time period during which that responder may respond to the initiator.

### TECHNICAL FIELD

The invention relates generally to wireless communication and, more particularly, to wireless networking.

### BACKGROUND OF THE INVENTION

There is currently a demand for higher network throughput in the wireless networking industry. One throughput-enhancing technique that is currently being considered allows an initiator device to address multiple responder devices during a single wireless frame exchange sequence. Techniques and structures for efficiently implementing such a multi-responder frame exchange sequence are needed.

### BRIEF DESCRIPTION OF THE DRAWINGS

FIG. 1 is a block diagram illustrating a wireless network arrangement having a wireless initiator device communicating with multiple responder devices;

FIG. 2 is a timing diagram illustrating an example frame exchange sequence that may occur in a wireless network in accordance with an embodiment of the present invention;

FIG. 3 is a flowchart illustrating an example method that may be used in connection with a wireless device operating as an initiator in a wireless network in accordance with an embodiment of the present invention;

FIG. 4 is a flowchart illustrating an example method that may be used in connection with a wireless device operating as a responder in a wireless network in accordance with an embodiment of the present invention; and

FIG. 5 is a block diagram illustrating an example wireless device in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention relates to strategies for increasing aggregate throughput in a wireless network. It was determined that overall throughput could be increased in a wireless network by allowing a single initiator device to address multiple responder devices within a frame exchange sequence. Techniques and structures are described herein for supporting such a multiple responder arrangement. As used herein, the term “initiator” refers to a wireless device that initiates a wireless frame exchange and the term “responder” refers to a wireless device that responds to the wireless frame exchange.

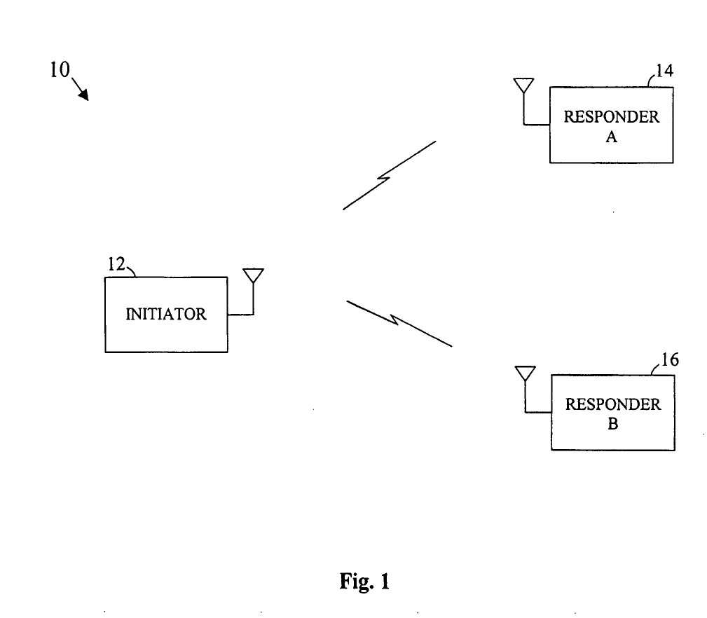

FIG. 1 is a block diagram illustrating a wireless network arrangement 10 having a wireless initiator device 12 communicating with two responder devices (RESPONDER A, RESPONDER B) 14, 16. As will be described in greater detail, during a single frame exchange sequence, the initiator 12 can transmit information to both of the responder devices 14, 16. In addition, in at least one embodiment, the responder devices 14, 16 will also be able to transmit data to the initiator device 12 during the same frame exchange sequence (i.e., using reverse direction data flow). Although illustrated with two responders in FIG. 1, it should be appreciated that any number of responders may be involved in a frame exchange sequence with an initiator in accordance with the present invention (although an upper limit on the number of responders may be imposed in any particular implementation).

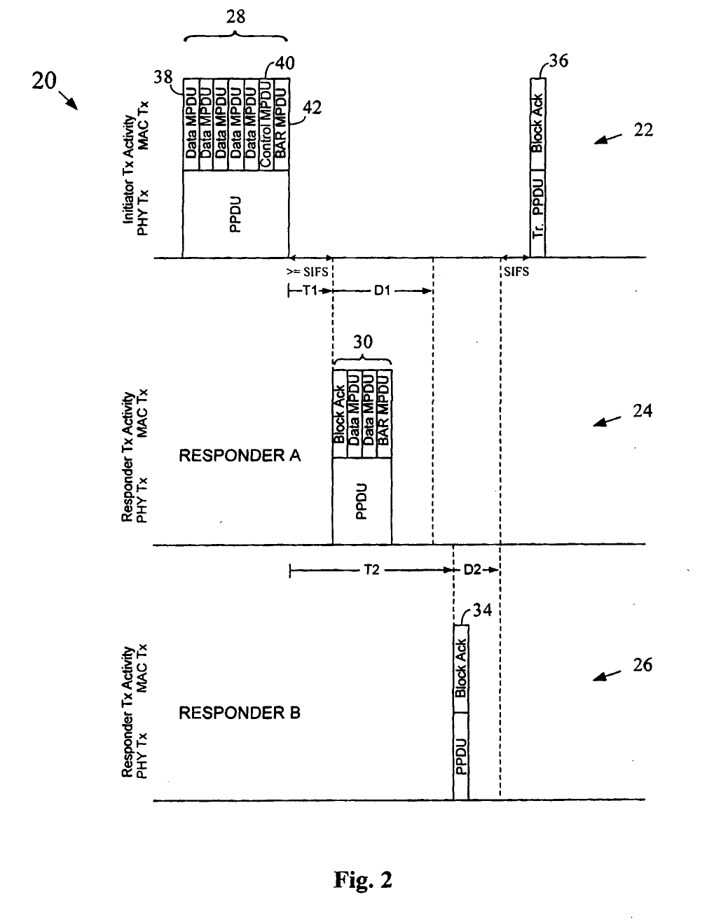

FIG. 2 is a timing diagram illustrating an example frame exchange sequence 20 that may occur in a wireless network in accordance with an embodiment of the present invention. An upper graph 22 in the diagram illustrates the transmit activity of an initiator of the frame exchange sequence 20. The lower graphs 24, 26 of the diagram illustrate the transmit activity of two responders (RESPONDER A, RESPONDER B). As shown, the transmissions of the initiator and the two responders are represented on both the physical layer (PHY Tx) and the media access control layer (MAC Tx) in the diagram. As illustrated, the initiator may transmit a frame 28 that includes, for example, one or more “data” management protocol data units (MPDUs) 38, a “control” MPDU 40, and a block acknowledgement request (BAR) MPDU 42. The data MPDUs 38 may include, for example, user data for delivery to the various responders. Each of the data MPDUs 38 may be directed to a specific responder device. The control MPDU 40 is operative for carrying offset and duration related information for each of the responders that are involved in the frame exchange sequence 20 (e.g., in list form, etc.). As will be described in greater detail, the offset and duration related information will indicate to each of the associated responders when and for how long they can respond to the initiator during the frame exchange sequence 20. Although illustrated as a single control MPDU 40 in FIG. 2, it should be appreciated that in other embodiments a separate control MPDU may be provided to carry offset and duration related information for each of the subject responders. The control MPDU(s) may be located anywhere within the frame 28. Other techniques for carrying the offset and duration related information for the responders within the frame transmitted by the initiator may alternatively be used. The BAR MPDU 42 requests that a block acknowledgement be transmitted by associated responders that successfully receive the frame 28. The BAR MPDU is a selective MPDU acknowledgement protocol, such as defined in the IEEE 802.11e standard.

When a responder that is involved in the frame exchange 20 receives the frame 28, the responder may process its associated data MPDUs and read its corresponding offset and duration related information from the control MPDU 40. The offset and duration related information associated with a responder will identify a transmit time period within which the responder may respond to the initiator during the frame exchange sequence 20. The transmit time period may be defined with respect to, for example, the end of the frame 28. In one approach, for example, the offset and duration related information may include an offset value and a duration value. The offset value may indicate the time offset from the end of the frame 28 to the beginning of the transmit time period of the responder. The duration value may indicate the duration of the transmit time period of the responder. The transmit time periods assigned to the various responders involved in the frame exchange may be such that no two responders will be permitted to transmit at the same instant in time (i.e., the transmit time periods will be non-overlapping). However, if spatial division multiple access (SDMA) is being used, the transmit time periods may be permitted to partially or fully overlap. The offset and duration related information may also be expressed in ways other than an offset value and a duration value within the frame transmitted by the initiator (e.g., a start time and a stop time with respect to the end of the frame 28, etc.).

With reference to FIG. 2, a first responder (RESPONDER A) has an offset of T1 and a duration of D1. The first responder may therefore begin to transmit T1 after the end of the frame 28 transmitted by the initiator. The first responder must complete its response transmission by the point (T1+D1) after the end of the frame 28. As shown, the first responder transmits a response frame 30 that ends before the end of the corresponding transmit time period. The response frame 30 transmitted by the first responder may include, for example, a block acknowledgement (Block Ack) in response to the BAR MPDU 42 within the frame 28. The response frame 30 may also include one or more data MPDUs to carry reverse direction user data back to the initiator. In at least one embodiment, the decision to allow or not to allow reverse direction data flow from a responder is made by the initiator. If the initiator does not want a responder to transmit reverse direction data, the initiator may set the duration of the transmit time period for that responder to a value that is not long enough to allow data to be transmitted (e.g., just long enough for a block acknowledgement, etc.). The response frame 30 may further include a BAR MPDU at an end thereof to request a block acknowledgement from the initiator. In one possible approach, the initiator may transmit a separate acknowledgement to each responder shortly after (e.g., a SIFS after) receiving a corresponding BAR MPDU from the responder. In another approach, as illustrated in FIG. 2, the initiator does not immediately send a block acknowledgement to a responder after receiving a BAR MPDU from the responder. Instead, the initiator waits until all responses have been received and then issues an aggregated acknowledgement 36 to all relevant responders. In this approach, after the first responder transmits the BAR MPDU within frame 30, it then waits for an acknowledgement within the next transmission of the initiator (and ignores any PPDUs transmitted by other responders in the meantime).

In a similar fashion to the first responder, a second responder (RESPONDER B) has an offset of T2 and a duration of D2 (see graph 26 in FIG. 2). Thus, the second responder may begin to transmit T2 seconds after the end of the frame 28 and must complete its response by the point (T2+D2) after the end of the frame 28. As shown, the second responder transmits a response frame 34 that includes only a block acknowledgement (Block Ack). The block acknowledgement is in response to the BAR MPDU 42 received from the initiator within frame 28. As illustrated in FIG. 2, the response frame 34 of the second responder does not include reverse direction user data. This may be because, for example, the second responder did not have any data buffered for delivery to the initiator at the time the frame 28 was transmitted by the initiator. It could also be because the initiator decided not to allow the second responder to transmit data in the reverse direction. As described above, if the initiator decides that it does not want a particular responder to transmit data in the reverse direction, the initiator may simply assign a duration to the responder that does not allow enough time to transmit reverse direction data. In at least one embodiment, the initiator may already have information about how mush data each responder has buffered for delivery to the initiator. The initiator may then set the duration of the transmit time periods for the responders accordingly.

As described previously, the initiator may transmit a single acknowledgement frame 36 to all responders after the responses have been received. The frame 36 may include acknowledgements for all relevant responders within a single MPDU or a separate acknowledgement MPDU for each responder. In one approach, the acknowledgement frame 36 will be transmitted a SIFS after the end of the final responder transmit time period. Other acknowledgement techniques may alternatively be used.

Although the frame exchange sequence 20 of FIG. 2 only involves two responders, it should be appreciated that any number of responders may take part in a frame exchange in accordance with the present invention (although an upper limit may be defined in any particular implementation). It should also be appreciated that the content of the various frames 28, 30, 34, 36 of the frame exchange sequence 20 of FIG. 2 is merely exemplary of one possible wireless frame exchange that can occur in accordance with the present invention. The frame content in other implementations may vary.

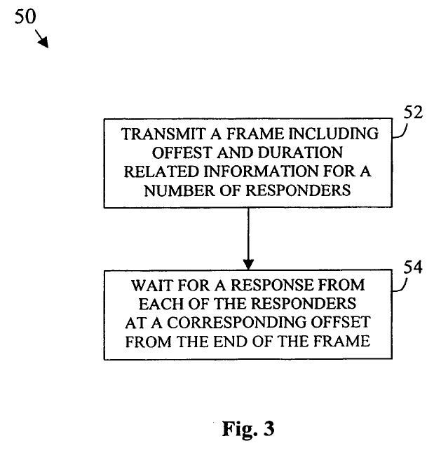

FIG. 3 is a flowchart illustrating an example method 50 that may be used in connection with a wireless device operating as an initiator in a wireless network in accordance with an embodiment of the present invention. A frame is first transmitted from an initiator that includes offset and duration related information for a number of responder devices (block 52). In at least one embodiment, the offset and duration related information for a responder device includes an offset value and a duration value. In some other embodiments, the offset and duration related information may include a start time and a stop time, or some other indication of a specific transmit time period (with respect to the frame transmitted by the initiator). After the frame has been transmitted by the initiator, the initiator waits for a response from each of the subject responders at corresponding offsets from the end of the frame (block 54). The initiator does not expect to receive any signals from a particular responder outside of the specific time period identified in the originally transmitted frame.

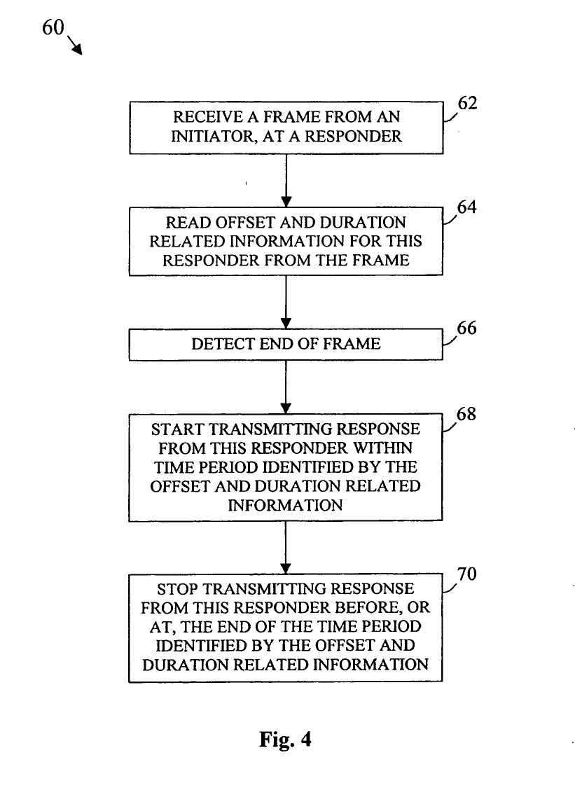

FIG. 4 is a flowchart illustrating an example method 60 that may be used in connection with a wireless device operating as a responder in a wireless network in accordance with an embodiment of the present invention. In at least one embodiment, the method 60 may be used by each of the responders involved in a frame exchange with an initiator. A frame is first received by a responder from an initiator (block 62). Offset and duration related information that is associated with the responder is then read from the frame (block 64). The offset and duration related information identifies a specific time period within which this responder may transmit back to the initiator. The offset and duration related information may include, for example, an offset value and a duration value, a start time and a stop time, or some other description of the transmit time period. The end of the received frame is subsequently detected (block 66). The responder may then start transmitting a response to the initiator within the transmit time period identified by the offset and duration related information (block 68). The responder stops transmitting the response to the initiator, however, before or at the end of the transmit time period identified by the offset and duration related information (block 70).

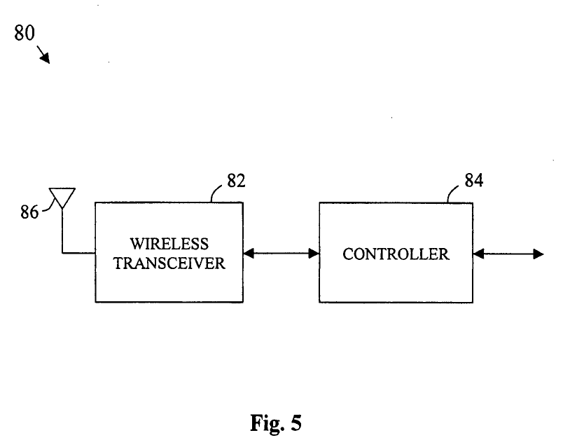

FIG. 5 is a block diagram illustrating an example wireless device 80 in accordance with an embodiment of the present invention. As illustrated, the wireless device 80 includes a wireless transceiver 82 and a controller 84. The wireless transceiver 82 is operative for supporting wireless communication with one or more remote wireless entities. The wireless transceiver 82 may be coupled to one or more antennas 86 to facilitate the transmission and reception of wireless signals. Any type of antenna(s) may be used including, for example, a dipole, a patch, a helical antenna, an antenna array, and/or others, including combinations of the above. The controller 84 is operative for, among other things, controlling the wireless networking functions of the wireless device 80. In at least one embodiment, the controller functionality may be implemented using one or more digital processing devices. The digital processing device(s) may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others. Hardware, software, firmware, and hybrid implementations may be used.

In at least one implementation, the wireless device 80 may be configured to operate as an initiator device. In such an implementation, the controller 84 may be programmed to transmit, for example, a wireless frame that includes offset and duration related information for a number of different responder devices in a vicinity thereof. Based on the offset and duration related information, the controller 84 will know when to expect a response, if any, from each of the corresponding responder devices. After the end of the frame, the controller 84 will simply wait for the responses of each of the responder devices at the appropriate times. The controller 84 may use one or more timers to keep track of the various transmit time periods.

In another implementation, the wireless device 80 maybe configured to operate as a responder device. As a responder device, the controller 84 may be programmed to wait for receipt of a wireless frame from an initiator device. When a frame is received, the controller 84 may, among other things, read offset and duration related information from the frame that is intended for the responder. As described previously, the offset and duration related information will identify a specific time period within which the responder is permitted to transmit a response to the initiator. The controller 84 may detect the occurrence of the end of the received frame and then wait for the transmit time period to commence. During the transmit time period, the controller 84 may cause a response to be transmitted to the initiator. The controller 84 will make sure, however, that the response transmission does not go on past the end of the identified transmit time period. In at least one embodiment, the controller 84 will use one or more timers to keep track of the timing of the transmit time period with respect the end of the frame received from the initiator. For example, in at least one embodiment, a timer may be started at the end of the frame received from the initiator and, when the timer reaches an offset value assigned to the wireless device 80, the controller 84 may begin to transmit a response. When the timer reaches a value equal to the sum of the offset value and the duration value associated with the wireless device 80, the controller 84 must cease transmission to the initiator (i.e., if the controller 84 hasn't already ceased transmission by this point).

In at least one embodiment, a wireless device 80 will be able to operate as both an initiator device and a responder device. The current mode of the wireless device 80 may depend upon whether or not the device performs the initial channel access that leads to initiation of a frame exchange sequence.

The wireless device 80 may be any type of device that is capable of communicating in a wireless network including, for example, a laptop, desktop, palmtop, or tablet computer having wireless networking capability, a personal digital assistant (PDA) having wireless networking capability, a cellular telephone or other handheld wireless communicator, a pager, a wireless computer peripheral, a wireless access point, and/or others. In at least one implementation, the wireless transceiver 82 and the controller 84 may be part of a wireless network interface card or other wireless network interface module.

In the description above, terminology is used that is related to the IEEE 802.11 wireless networking standard (and its progeny). It should be appreciated, however, that the inventive principles also have application in wireless networks and systems following other wireless standards. In addition, the embodiments discussed above describe frame exchanges that involve multiple responder devices, where offset and duration related information is provided for each of the multiple responder devices. It should be appreciated that a frame exchange sequence involving a single responder (with corresponding offset and duration related information) may also occur in at least one embodiment.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

1. A method for use in a wireless network, comprising:
transmitting a frame from an initiator to a group of responders as part of a frame exchange, said frame including offset and duration related information for each responder within said group of responders, wherein said offset and duration related information for a particular responder within said group identifies a transmit time period within which said particular responder may transmit a response back to said initiator; and
waiting for a response from each member of said group of responders within an associated transmit time period.

2. The method of claim 1, wherein:
said group of responders includes multiple responders.

3. The method of claim 1, wherein:
said group of responders includes a single responder.

4. The method of claim 1, wherein:
said offset and duration related information includes an offset value and a duration value for each member of said group of responders, said offset value indicating a time after an end of said frame at which a corresponding transmit time period commences and said duration value indicating a duration of said corresponding transmit time period.

5. The method of claim 1, wherein:
said offset and duration related information includes a start time and a stop time for each member of said group of responders, said start time indicating a time after an end of said frame at which a corresponding transmit time period commences and said stop time indicating a time after said end of said frame at which said corresponding transmit time period ends.

6. A method for use in a wireless network, comprising:
receiving a wireless frame from an initiator at a first responder during a frame exchange, said wireless frame including offset and duration related information associated with said first responder that identifies a transmit time period within which said first responder is permitted to transmit a response back to said initiator;
reading said offset and duration related information associated with said first responder from said wireless frame; and
beginning to transmit a response from said first responder to said initiator within said transmit time period.

7. The method of claim 6, further comprising:
ceasing transmission of said response from said first responder to said initiator before, or at, the end of said transmit time period.

8. The method of claim 6, wherein:
said wireless frame includes offset and duration related information associated with multiple responders.

9. The method of claim 6, wherein:
said offset and duration related information associated with said first responder includes an offset value and a duration value, said offset value indicating a time after an end of said wireless frame at which said transmit time period commences and said duration value indicating a duration of said transmit time period.

10. The method of claim 6, wherein:
said offset and duration related information associated with said first responder includes a start time and a stop time, said start time indicating a time after an end of said wireless frame at which said transmit time period commences and said stop time indicating a time after said end of said wireless frame at which said transmit time period ends.

11. An apparatus comprising:
a wireless transceiver to support wireless communication with one or more remote wireless entities; and
a controller to control wireless networking functions of said apparatus, wherein said controller is programmed to: receive a frame from an initiator device during a frame exchange sequence; read offset and duration related information associated with said apparatus from said frame, said offset and duration related information associated with said apparatus identifying a transmit time period within which said apparatus may transmit a response back to said initiator device; detect an end of said received frame;
and start transmitting a response to said initiator device within said identified transmit time period.

12. The apparatus of claim 11, wherein:
said frame received from said initiator device includes offset and duration related information associated with multiple devices.

13. The apparatus of claim 11, wherein:
said controller is programmed to stop transmitting said response to said initiator device before, or at, an end of said identified transmit time period.

14. An apparatus comprising:
a wireless transceiver to support wireless communication with one or more remote wireless entities; and
a controller to control wireless networking functions of said apparatus, wherein said controller is programmed to: transmit a frame to a group of responders as part of a frame exchange, said frame including offset and duration related information for each responder within said group of responders, said offset and duration related information for a particular responder identifying a transmit time period within which said particular responder may transmit a response back to said apparatus.

15. The apparatus of claim 14, wherein:
said controller is programmed to wait for a response from each of said multiple responders within a corresponding transmit time period.

16. The apparatus of claim 14, wherein:
said group of responders includes multiple responders.

17. An article comprising a storage medium having instructions stored thereon that, when executed by a computing platform, operate to:
transmit a frame from an initiator to a group of responders as part of a frame exchange, said frame including offset and duration related information for each responder within said group of responders, wherein said offset and duration related information for a particular responder within said group identifies a transmit time period within which said particular responder may transmit a response back to said initiator; and
wait for a response from each responder in said group of responders within an associated transmit time period.

18. The article of claim 17, wherein:
said offset and duration related information includes an offset value and a duration value for each responder within said group, said offset value indicating an offset from an end of said frame at which a corresponding transmit time period commences and said duration value indicating a duration of said corresponding transmit time period.

19. The article of claim 17, wherein:
said offset and duration related information includes a start time and a stop time for each responder within said group, said start time indicating a time after an end of said frame at which a corresponding transmit time period commences and said stop time indicating a time after said end of said frame at which said corresponding transmit time period ends.

20. An article comprising a storage medium having instructions stored thereon that, when executed by a computing platform, operate to:
receive a wireless frame from an initiator at a first responder during a frame exchange, said wireless frame including offset and duration related information associated with said first responder that identifies a transmit time period within which said first responder is permitted to transmit a response back to said initiator;
read said offset and duration related information associated with said first responder from said wireless frame; and
begin to transmit a response from said first responder to said initiator within said transmit time period.

21. The article of claim 20, wherein said instructions further operate to:
cease transmission of said response from said first responder to said initiator before, or at, the end of said transmit time period.

22. The article of claim 20, wherein:
said offset and duration related information associated with said first responder includes an offset value and a duration value, said offset value indicating a time after an end of said frame at which said transmit time period commences and said duration value indicating a duration of said transmit time period.

23. The article of claim 20, wherein:
said offset and duration related information associated with said first responder includes a start time and a stop time, said start time indicating a time after an end of said frame at which a corresponding transmit time period commences and said stop time indicating a time after said end of said frame at which said corresponding transmit time period ends.

24. A wireless device comprising:
at least one dipole antenna;
a wireless transceiver, coupled to said at least one dipole antenna, to support wireless communication with one or more remote wireless entities; and
a controller to control wireless networking functions of said wireless device, wherein said controller is programmed to: receive a frame from an initiator device during a frame exchange sequence; read offset and duration related information associated with said wireless device from said frame, said offset and duration related information associated with said wireless device identifying a transmit time period within which said wireless device may transmit a response back to said initiator device; detect an end of said received frame; and start transmitting a response to said initiator device within said identified transmit time period.

25. The wireless device of claim 24, wherein:
said controller is programmed to stop transmitting said response to said initiator device before, or at, an end of said identified transmit time period.

26. The wireless device of claim 24, wherein:
said frame received from said initiator device includes offset and duration related information associated with multiple devices.

27. A wireless device comprising:
at least one dipole antenna;
a wireless transceiver, coupled to said at least one dipole antenna, to support wireless communication with one or more remote wireless entities; and
a controller to control wireless networking functions of said wireless device, wherein said controller is programmed to: transmit a frame to a group of responders as part of a frame exchange, said frame including offset and duration related information for each responder within said group of responders, said offset and duration related information for a particular responder identifying a transmit time period within which said particular responder may transmit a response back to said wireless device.

28. The wireless device of claim 27, wherein:
said controller is programmed to wait for a response from each responder in said group of responders within an associated transmit time period.

29. The wireless device of claim 27, wherein:
said group of responders includes multiple responders.

30. A wireless signal frame embodied in a carrier wave, said wireless signal frame comprising:
first offset and duration related information corresponding to a first responder device, said first offset and duration related information identifying a first transmit time period within which said first responder device is permitted to transmit a response to an initiator device; and
second offset and duration related information corresponding to a second responder device, said second offset and duration related information identifying a second transmit time period within which said second responder device is permitted to transmit a response to said initiator device.

31. The wireless signal frame of claim 30, wherein:
said first offset and duration related information includes an offset value and a duration value, said offset value indicating an offset from an end of said wireless signal frame at which said first transmit time period commences and said duration value indicating a duration of said first transmit time period.

32. The wireless signal frame of claim 30, wherein:
said first offset and duration related information includes a start time and a stop time, said start time indicating a time after said end of said wireless signal frame at which said first transmit time period commences and said stop time indicating a time after said end of said wireless signal frame at which said first transmit time period ends.

33. The wireless signal frame of claim 30, further comprising:
offset and duration related information corresponding to at least one responder device other than said first and second responder devices.

34. The wireless signal frame of claim 30, wherein:
said first offset and duration related information and said second offset and duration related information are modulated within a common MPDU of said wireless signal frame.

35. The wireless signal frame of claim 30, wherein:
said first offset and duration related information and said second offset and duration related information are each modulated within a separate MPDU of said wireless signal frame.
